(19) United States
(12) Patent Application Publication
(10) Pub. No.: US 2007/0116537 A1
(43) Pub. Date: May 24, 2007

(54) Push-back fastener

(76) Inventor: Dan Glovak, Troy, MI (US)

Correspondence Address: CLARK HILL, P.C., 500 WOODWARD AVENUE, SUITE 3500, DETROIT, MI, 48226, US

(21) Appl. No.: 11/594,509

(22) Filed: Nov. 8, 2006

Related U.S. Application Data
(60) Provisional application No. 60/734,625, filed on Nov. 8, 2005.

(51) Int. Cl. F16B 13/06

(52) U.S. Cl. 411/45

(57) ABSTRACT

A fastener is provided for attaching a first member to a second member. The fastener includes a head, a shank having a first end abutting the head and an opposing second end. An entry guide extends out from the second end of the shank for guiding the fastener into engagement with the second member. An alignment rod extends out from the entry guide for aligning the fastener with the second member. The fastener also includes at least one wing extending out from the shank for engaging the second member and urging the second member into constant engagement with the entry guide.

### CROSS-REFERENCE TO RELATED APPLICATION

This application claims priority to and all the benefits of U.S. Provisional Patent Application Ser. No. 60/734,625, filed Nov. 8, 2005 and entitled “Push-back Fastener.”

### BACKGROUND OF THE INVENTION

1. Field of the Invention

The invention relates to a fastener for attaching a first member to a second member. More particularly, the invention relates to a fastener engaging opposing sides of a base member to attach the base member to an attachment member.

2. Description of Related Art

Push-in fasteners are often used in the automotive industry to secure two members together. Such push-in fasteners typically include a head and a shank having at least one resilient fin which deforms to allow insertion of the shank through an aperture in the members. Once the fin passes through the apertures, the fin springs or bounces back to its original position to prevent the fastener from being pulled back out through the apertures. Thus, the at least one fin retains the shank within the aperture of the member.

One common push-in fastener is referred to as a Christmas Tree fastener. Such Christmas Tree fasteners typically utilize a plurality of axially spaced apart and parallel fins positioned along a shank. Another common push-in fastener is referred to as an arrow fastener and includes a deformable arrow-shaped member at one end of a shank. The deformable arrow-shaped member deforms upon insertion of the fastener through one or more apertures. The arrow-shaped member does not allow the fastener to be pulled back out of the apertures without destroying the fastener. Each of the afore-mentioned push-in fasteners have a common drawback—they engage only one side of a member. This results in excessive rattling and an inability to control the position of the attachment to the member after installation.

### SUMMARY OF THE INVENTION

According to one aspect of the invention, a fastener is provided for attaching a first member to a second member. The fastener includes a head and a shank having a first end abutting the head and an opposing second end. An entry guide extends out from the second end of the shank for guiding the fastener into engagement with the second member. An alignment rod extends out from the entry guide for aligning the fastener with the second member. The fastener also includes at least one wing extending out from the shank for engaging the second member and urging the second member into constant engagement with the entry guide.

### BRIEF DESCRIPTION OF THE DRAWINGS

The invention will be readily appreciated as the same becomes better understood by reference to the following detailed description when considered in connection with the accompanying drawings wherein:

FIG. 1 is a perspective view of a fastener according to one embodiment of the invention;

FIG. 2 is a cross-sectional view of the fastener fixedly securing an attachment member to a base member;

FIG. 3 is a cross-sectional view of the fastener integrally formed with the attachment member for joining the base member thereto; and

FIG. 4 is a fragmentary, perspective view of a fastener according to a second embodiment of the invention integrally formed with an attachment member.

### DETAILED DESCRIPTION OF THE PREFERRED EMBODIMENTS

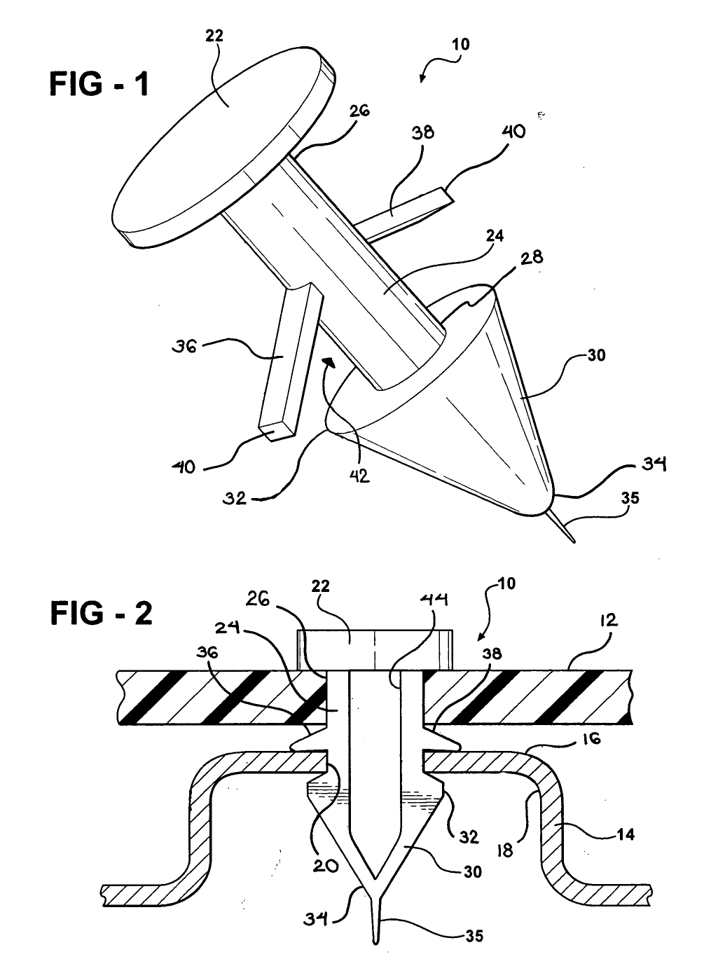

Referring to FIGS. 1 and 2, a fastener, generally shown at 10, according to one embodiment of the invention is utilized to attach at least one first member 12 to a second member 14. Preferably, the first member 12 is an attachment member and the second member 14 is a base member. The base member 14 includes a first side 16 and an opposing second side 18. The base member 14 defines a base aperture 20 extending from the first side 16 through the second side 18. The fastener 10 extends through the base aperture 20 to join the attachment member 12 to the base member 14.

The fastener 10 includes a head 22 and a shank 24 extending out therefrom. The shank 24 includes a first end 26 abutting the head 22, and an opposing second end 28. The shank 24 has a length extending between the first 26 and second 28 ends. The particular length of the shank 24 may vary. Preferably, the cross-section of the shank 24 is circular. It is, however, appreciated that the shank 24 may have any of a variety of cross-sectional shapes.

An entry guide 30 is located at the second end 28 of the shank 24 to aid insertion of the fastener 10 into the base aperture 20 of the base member 14. The entry guide 30 preferably has a conical shape and extends between a wide end 32 and an opposing pointed end 34. The wide end 32 and the pointed end 34 each have a width. The width of the wide end 32 is greater than the width of the pointed end 34. Moreover, the width of the wide end 32 of the entry guide 30 is also greater than a width of the shank 24. An alignment rod 35 extends out from the pointed end 34 of the entry guide 30. Together, the entry guide 30 and the alignment rod 35 align the fastener 10 with the base aperture 20.

The fastener 10 further includes a pair of wings 36, 38 spaced apart from the entry guide 30 and extending out from the shank 24 at a location between the wide 32 and pointed 34 ends thereof. Each of the pair of wings 36, 38 terminates at a distal end 40 spaced away from the shank 24. In addition, each of the pair of wings 36, 38 is attached to the shank 24 such that the pair of wings 36, 38 extends outwardly therefrom in an angular fashion. More specifically, each of the pair of wings 36, 38 extends outwardly and downwardly towards the entry guide 30. The pair of wings 36, 38 is formed from a flexible material that allows the pair of wings 36, 38 to flex towards the head 22 of the fastener 10 as the fastener 10 is being installed. A channel 42 is formed adjacent the shank 24 between the pair of wings 36, 38 and the entry guide 30.

The fastener 10 further includes a hollow interior portion 44 extending generally from the first end 26 of the shank 24 into the entry guide 30. The hollow interior portion 44 allows inward deformation of the entry guide 30 to facilitate insertion of the fastener 10 through the base aperture 20 of the base member 14.

The fastener 10 may be formed from any of numerous materials. Preferably, the fastener 10 is formed from a plastic material due to its strength, cost-effectiveness, and ability to withstand distortion. Materials such as polypropylene, polyethylene, and nylon are particularly suitable for the fastener 10.

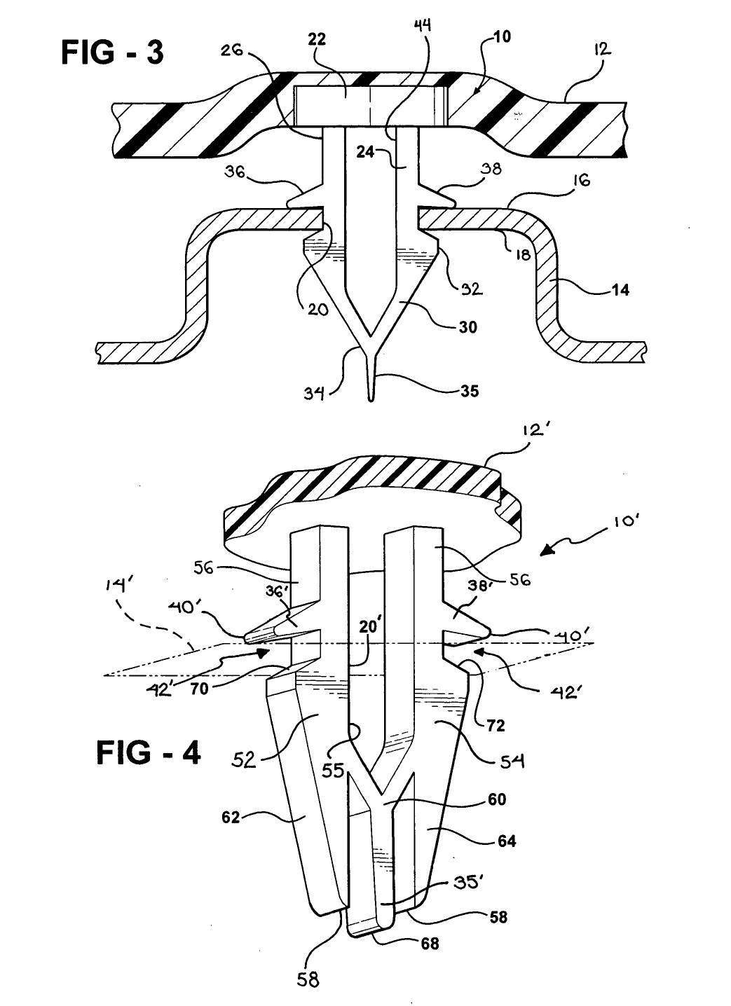

It is appreciated that although the fastener 10 and at least one attachment member 12 have been set forth as separate components, the fastener 10 may be integrally formed with the attachment member 12, as shown in FIG. 3.

In operation, to attach the attachment member 12 to the base member 14, the fastener 10, with the attachment member 12 secured thereto, is first aligned with the base aperture 20 by way of the entry guide 30 and the alignment rod 35. The fastener 10 is then pushed through the base aperture 20 until the wide end 32 of the entry guide 30 clears the second side 18 of the base member 14. The base aperture 20 has a width that is less than the width of the wide end 32 of the entry guide 30. Thus, the entry guide 30 temporarily deforms in order to allow passage thereof through the base aperture 20. Such deformation of the entry guide 30 is facilitated by the hollow interior portion 44 of the fastener 10. Once the entry guide 30 passes through the base aperture 20, the wide end 32 of the entry guide 30 abuts the second side 18 of the base member 14 to prevent the fastener 10 from being pulled back through the base aperture 20, thereby attaching the attachment member 12 to the base member 14. When the fastener 10 is fully installed, the distal end 40 of each of the pair of wings 36, 38 engages the first side 16 of the base member 14 to urge the base member 14 into constant engagement with the wide end 32 of the entry guide 30. The ability of the wings 36, 38 to flex accommodates base members 14 of varying widths and tolerance variations.

The engagement of the wings 36, 38 pushing against the first side 16 of the base member 14 urges the second side 18 of the base member 14 against the wide end 32 of the entry guide 30 to retain the base member 14 in a tight fit between the wings 36, 38 and entry guide 30, thereby eliminating rattle that would be otherwise produced by the vertical shifting of the base member 14 along the shank 24 between the first 26 and second 28 ends thereof. This engagement also improves the ability to control the position of the attachment member 12 after installation of the fastener 10 and improves the retention of the attachment member 12 to the base member 14.

Referring to FIG. 4, wherein like primed reference numerals represent similar elements as those described above, the fastener 10′ in a second embodiment of the invention is integrally formed with the attachment member 12′ and includes a pair of spaced apart, flexible legs 52, 54 extending out therefrom. The pair of spaced apart legs 52, 54 defines an elongated opening 55 therebetween. Each of the spaced apart legs 52, 54 extends between a connecting end 56 abutting the attachment member 12′ and an opposing distal free end 58. The legs 52, 54 are interconnected generally midway between the ends 56, 58 by a center bridge 60. The portion of each leg 52, 54 extending from the center bridge 60 to the distal free end 58 forms a respective flexible finger 62, 64. The flexible fingers 62, 64 form an entry guide that is received within and through the base aperture 20′ formed in the base member 14′. The flexible fingers 62, 64 deform inwardly to facilitate insertion of the fastener 10′ into the base aperture 20′ of the base member 14′.

The fastener 10′ includes the alignment rod 35′ extending out from the center bridge 60. The alignment rod 35′ terminates at a leading end 68 which extends beyond the distal free end 58 of each of the pair of spaced apart legs 52, 54 for aligning the fastener 10′ with the base aperture 20′ formed in the base member 14′.

Each of the spaced apart legs 52, 54 flares outwardly from the distal free end 58 thereof to a respective abutment wall 70, 72. The abutment walls 70, 72 have a diametrical width that is greater than a diameter or width of the base aperture 14′ of the base member 12′.

Each of the spaced apart legs 52, 54 also includes one of the pair of flexible wings 36′, 38′ extending out therefrom. More specifically, each of the pair of wings 36′, 38′ extends laterally outwardly from each leg 52, 54 toward the distal free end 58 thereof. A channel 42′ is defined by the pair of wings 36′, 38′ and the abutment walls 70, 72 alongside each leg 52, 54 for receiving and retaining the base member 14′. It is appreciated that the installation of the fastener 10′ to join the attachment member 12′ to the base member 14′ proceeds in the same manner as the above-described first embodiment of the invention with the wings 36′, 38′ engaging the first side 16′ of the base member 14′ and urging the second side 18′ of the base member 14′ against the abutment walls 70, 72.

One skilled in the art will appreciate that many modifications of the fastener 10 are possible. For example, the entry guide 30 could, instead of having a conical shape, be an additional set of wings that angle upwards towards the head 22 of the fastener 10. As another example, the entry guide 30 could include one or more relatively flexible fins integrally formed at the second end 28 of the shank 24 such that, upon insertion of the fastener 10 through the base aperture 20, the fins would flex towards the head 22 and successively engage the second side 18 of the base member 14 to connect the attachment member 12 to the base member 14. In yet another example, the wings 36, 38 may include one or more disc-shaped fins extending around a perimeter of the shank 24 to form a flexible rib therealong.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed:

1. A fastener for attaching a first member to a second member, said fastener comprising:
a head;
a shank having a first end abutting said head and an opposing second end;
an entry guide extending out from said second end of said shank for guiding said fastener into engagement with the second member;
an alignment rod extending out from said entry guide for aligning said fastener with the second member; and
at least one wing extending out from said shank for engaging the second member and urging the second member into constant engagement with said entry guide.

2. A fastener as set forth in claim 1 wherein said at least one wing and said entry guide define a channel therebetween for receiving the second member.

3. A fastener as set forth in claim 2 wherein said at least one wing includes a distal end for engaging one side of the first member to urge a second side of the second member against said entry guide.

4. A fastener as set forth in claim 3 wherein said entry guide includes a wide end adjacent said second end of said shank and an opposing pointed end.

5. A fastener as set forth in claim 4 including a hollow interior portion extending at least partially from said entry guide to said shank.

6. A fastener as set forth in claim 3 wherein said entry guide is conical shaped.

7. A fastener for attaching an attachment member to a base member having a first side, a second side, and a base aperture extending therethrough, said fastener comprising:
a head;
a shank having a first end abutting said head and an opposing second end;
an entry guide extending out from said second end of said shank, said entry guide adapted to engage the second side of the base member upon insertion through the base aperture; and
at least one wing extending out from said shank between said first and second ends, said at least one wing adapted to engage the first side of the base member and urge the second side of the base member into constant engagement with said entry guide.

8. A fastener as set forth in claim 7 wherein said entry guide includes an alignment rod extending out therefrom for aligning said fastener with the base aperture of the base member.

9. A fastener as set forth in claim 8 wherein said at least one wing and said entry guide define a channel therebetween for receiving the second member.

10. A fastener as set forth in claim 9 wherein said entry guide includes a wide end and an opposing pointed end.

11. A fastener as set forth in claim 10 wherein said shank defines a hollow interior portion extending into a portion of said entry guide.

12. A fastener as set forth in claim 9 wherein said entry guide is conical shaped.

13. A fastener for attaching an attachment member to a base member having a first side, a second side, and a base aperture extending through the first and second sides, said fastener comprising:
a pair of spaced apart legs adapted to be secured to the attachment member, each of said spaced apart legs further including an abutment wall engaging the second side of the base member upon insertion of said fastener into the base aperture; and
a wing extending out from each of said pair of spaced apart legs and spaced apart from said abutment wall for engaging the first side of the base member and urging the second side of the base member into constant engagement with said abutment walls.

14. A fastener as set forth in claim 13 wherein said wings and said respective abutment walls entry guide define a channel therebetween for receiving the second member.

15. A fastener as set forth in claim 14 wherein each of said wings includes a distal end abutting the first side of the base member to urge the base member against said abutment walls.

16. A fastener as set forth in claim 15 including a center bridge interconnecting said pair of spaced apart legs.

17. A fastener as set forth in claim 16 wherein one end of each of said pair of spaced apart legs forms a flexible finger.

18. A fastener as set forth in claim 17 including an alignment rod extending out from said center bridge for aligning said fastener with the base aperture of the base member.

19. A fastener as set forth in claim 18 wherein said alignment rod includes a leading end extending beyond said distal free end of each of said pair of spaced apart legs.
